(19) United States
(12) Patent Application Publication
(10) Pub. No.: US 2008/0076313 A1
(43) Pub. Date: Mar. 27, 2008

(54) Wipe and methods for manufacturing and using a wipe

(76) Inventors: David Uitenbroek, Sun Prairie, WI (US); John James Blanz, Mosinee, WI (US)

Correspondence Address: MERCHANT & GOULD PC, P.O. BOX 2903, MINNEAPOLIS, MN, 55402-0903, US

(21) Appl. No.: 11/528,705

(22) Filed: Sep. 26, 2006

(51) Int. Cl. D04H 13/00; B32B 21/10; D04H 1/00

(52) U.S. Cl. 442/327; 442/413; 442/417

(57) ABSTRACT

A wipe is provided including a nonwoven substrate and an active agent containing composition. The nonwoven substrate includes a mixture of natural fiber and regenerated cellulose fiber. The nonwoven substrate can contain about 0.5 wt. % to about 75 wt. % of the regenerated cellulose fiber and about 10 wt. % to about 95 wt. % of the natural fiber. The nonwoven substrate can have a basis weight of about 10 lb/3000 ft² to about 50 lb/3000 ft². The wipe can contain the active agent containing composition in an amount of about 0.5 lb/3000 ft² to about 300 lb/3000 ft². The wipe can be provided so that it satisfies the definition for biodegradability according to ASTM D 6868-03. A method for manufacturing a wipe is provided.

### FIELD OF THE INVENTION

The present invention relates to a wipe, and to methods for using a wipe. The wipe includes a nonwoven substrate that contains natural fiber and regenerated cellulose fiber, and active agent. The wipe can be provided as a wet wipe or as a dry to touch wipe, and can be available for use in wiping a hard surface such as a counter, a floor, furniture, tile, ceramic, etc. The wipe can be contained in packaging as a single wipe or can be contained in packaging as multiple wipes.

### BACKGROUND OF THE INVENTION

Wet wipes are typically pre-moistened, disposable towelettes which may be utilized in a variety of applications both domestic and industrial, and perform a variety of functions. Wet wipes can be used to wipe inanimate surfaces. In addition, wipes can be used as personal hygiene wipes (e.g. hand wipes) for cleaning various parts of the body. Wet wipes can provide numerous benefits such as cleaning, cleansing, and disinfecting.

One particular application for wet wipes is wiping and/or cleaning surfaces and the application of compositions to surfaces, for example, kitchen and bathroom surfaces, spectacles, shoes and surfaces which require cleaning in industry, for example, surfaces of machinery or vehicles.

Wet wipes are commonly constructed from webs of combinations of synthetic, man-made and natural fibres, such as polyolefin fibres, viscose fibres, cotton fibres, which are generally moistened with an aqueous composition which may contain amongst other ingredients surfactants, preservatives, oils and scents depending on the end use envisaged.

Disposable wipes for cleaning hard surfaces are described. See WO 89/05114 and EP 0 211 773. Wipes can be provided from fabric of natural or synthetic fibers, and can include an antimicrobial agent. See EP 0 113 254 and EP 0 233 943

Traditionally, hard surface cleaning wipes have been made using synthetic fibres because synthetic fibres provide sufficient strength in the wipe for it to withstand the stress and strain of the cleaning action. Wipes made using natural and synthetic fibres have generally been much weaker in terms of tensile strength and have required the use of a binder or wet strength agent to increase the tensile strength to a level suitable to withstand the cleaning action. EP 0 602 881 discloses a wet wipe comprising wool pulp and man-made fibres made preferably for use in personal hygiene, for example as moist toilet paper. The wipes also comprise a wet strength agent, for example polyacrylamide, to improve the wet strength of the wipe.

### SUMMARY OF THE INVENTION

A wipe is provided according to the invention. The wipe includes a nonwoven substrate and an active agent containing composition. The nonwoven substrate includes a mixture of natural fiber and regenerated cellulose fiber. The nonwoven substrate can contain about 0.5 wt. % to about 75 wt. % of the regenerated cellulose fiber and about 10 wt. % to about 95 wt. % of the natural fiber. The nonwoven substrate can have a basis weight of about 10 lb/3000 ft² to about 50 lb/3000 ft². The wipe can contain the active agent containing composition in an amount of about 0.5 lb/3000 ft² to about 300 lb/3000 ft².

A method for manufacturing a wipe is provided according to the invention. The method includes the step of forming a nonwoven substrate and a step of loading an active agent containing composition onto the nonwoven substrate. The nonwoven substrate can be formed from a mixture of natural fiber and regenerated cellulose fiber by a wet laid process. The mixture can contain about 0.5 wt. % to about 75 wt. % of the regenerated cellulose fiber and about 10 wt. % to about 95 wt. % of the natural fiber. The active agent containing composition can be loaded onto the nonwoven substrate in an amount of about 0.5 lb/3000 ft² to about 300 lb/3000 ft²

### DETAILED DESCRIPTION

A wipe includes a nonwoven substrate and an active agent containing composition loaded onto the nonwoven substrate. The wipe can be used for various applications including cleaning, dusting, disinfectant, deodorizing, moisturizing, imparting a fragrance, etc. The wipe can be provided as a moist wipe or as a wipe that is dry to touch. A wipe that is dryer to touch generally has a dry or nontacky feel. The wipe can be packaged as a single wipe or the wipe can be packaged in a container having multiple wipes.

The wipe can be provided as a biodegradable wipe. In general, a biodegradable wipe is a wipe that satisfies the definition for biodegradability established by ASTM D 6868-03. It should be understood that the wipe does not have to satisfy the biodegradability definition of ASTM D 6868-03. If desired, the wipe can be provided so that it does satisfy the biodegradability definition of ASTM D 6868-03.

### Nonwoven Substrate

The nonwoven substrate can be formed from a mixture of natural fiber and regenerated cellulose fiber. The substrate can include a sufficient amount of regenerated cellulose fiber to provide the nonwoven substrate with desired cloth or hand feel characteristics, and to provide the nonwoven substrate with desired porosity.

Natural fiber refers to fiber formed from plants or animals. Natural fibers are not fibers that are formed as a result of extrusion or spinning. The natural fibers can be obtained from a source of fiber using techniques such as chemical pulping, chemical mechanical pulping, semi chemical pulping, or mechanical pulping. Natural fibers from plants are often referred to as cellulosic fibers.

Exemplary natural fibers that can be used to form the nonwoven substrate include wood fibers and non-wood natural fibers such as vegetable fibers, cotton, various straws (e.g., wheat and rye), various canes (e.g., bagasse and kenaf), silk, animal fiber (e.g., wool), grasses (e.g., bamboo), hemp, corn stalks, abaca, etc.

Wood fiber can be obtained from wood pulp. The wood pulp can include hardwood fibers, softwood fibers, or a blend of hardwood fibers and softwood fibers. The pulp can be provided as cellulose fiber from chemical pulped wood, and can include a blend from coniferous and deciduous trees. By way of example, wood fibers can be from northern hardwood, northern softwood, southern hardwood, or southern softwood. Hardwood fibers tend to be more brittle but are generally more cost effective for use because the yield of pulp from hardwood is higher than the yield of pulp from softwood. The pulp can contain about 0 to about 100% hardwood fibers (or about 0 to 70%) based on the weight of the fibers. Softwood fibers have desired paper making characteristics but are generally more expensive than hardwood fibers. The pulp can contain about 0 to about 100% softwood fibers based on the weight of the fibers. The pulp can contain a blend of hardwood and softwood fibers.

The natural fibers can be extracted with various pulping techniques. For example, mechanical or high yield pulping can be used for stone ground wood, pressurized ground wood, refiner mechanical pulp, and thermomechanical pulp. Chemical pulping can be used incorporating kraft, sulfite, and soda processing. Semi-chemical and chemi-mechanical pulping can also be used which includes combinations of mechanical and chemical processes to produce chemi-thermomechanical pulp.

The natural fibers can also be bleached or unbleached. One of skill in the art will appreciate that the bleaching can be accomplished through many methods including the use of chlorine, hypochlorite, chlorine dioxide, oxygen, peroxide, ozone, or a caustic extraction.

The pulp can include a recycle source for reclaimed fiber. Exemplary recycle sources include post-consumer waste (PCW) fiber, office waste, and corrugated carton waste. Post-consumer waste fiber refers to fiber recovered from paper that is recycled after consumer use. Office waste refers to fiber obtained from office waste, and corrugated carton waste refers to fiber obtained from corrugated cartons. Additional sources of reclaimed fiber include newsprint and magazines. Reclaimed fiber can include both natural and synthetic fiber. Incorporation of reclaimed fiber in the nonwoven substrate can aid in efficient use of resources and increase satisfaction of the end user of the wipe.

Refining is the treatment of pulp fibers to develop their papermaking properties. Refining increases the strength of fiber to fiber bonds by increasing the surface area of the fibers and making the fibers more pliable to conform around each other, which increases the bonding surface area and leads to a denser sheet, with fewer voids. Most strength properties of paper increase with pulp refining, since they rely on fiber to fiber bonding. The tear strength, which depends highly on the strength of the individual fibers, actually decreases with refining. Refining of pulp increases the fibers flexibility and leads to a denser substrate. This means bulk, opacity, and porosity decrease (densometer values increase) with refining. Fibrillation is a result of refining paper fibers. Fibrillation is the production of rough surfaces on fibers by mechanical and/or chemical action; refiners break the outer layer of fibers, e.g., the primary cell wall, causing the fibrils from the secondary cell wall to protrude from the fiber surfaces.

The fibers can be refined so that the resulting nonwoven substrate provides the desired Canadian Standard Freeness value. In general, less refined fiber can provide a nonwoven substrate having more holes and voids and thereby permitting greater penetration into the nonwoven substrate. It may be desirable to provide a desired level of refining to control the presence of holes or voids so that the nonwoven substrate can contain a desired amount or loading of the active agent containing composition.

Regenerated cellulose fiber can be considered a type of fiber prepared from cellulose and wherein the fiber is formed as a result of extrusion or spinning. An exemplary regenerated cellulose fiber can be referred to as rayon or as viscose. It is understood that viscose is generally another term for rayon. Various forms of rayon are available and can be referred as high wet modulus rayon, cuprammonium rayon, saponified rayon, and high tenacity rayon. High wet modulus rayon can be characterized as highly modified rayon that has greater dimensional stability in washing. Cuprammonium rayon refers to rayon made by converting the cellulose into a water soluble compound by combining it with copper and ammonia. Saponified rayon generally refers to extruded filaments of cellulose acetate that are reconverted to cellulose. General characteristic of rayon include high absorbency, softness, and desirable drape. Another form of rayon can be referred as lyocell. Lyocell is often referred as a type of rayon. For example, the United States Federal Trade Commission classifies lyocell fiber as a sub-category of rayon. In general, lyocell can be characterized as a cellulose fabric obtained by an organic solvent spinning process. According to this disclosure, lyocell is considered a type of rayon.

Exemplary disclosures of rayon are described by, for example, “Rayon Fiber (Viscose),” http://fibersource.com/f-tutor/rayon.htm, 5 pages, date printed Sep. 15, 2006; “Lyocell Fiber, Lyocell Staple Fiber,” http://www.fibersource.com/f-tutor/lyocell.htm, 1 page, date printed Sep. 15, 2006; “Rayon,” http://en.wikipedia.org/wiki/Rayon, 4 pages, date printed Sep. 18, 2006; “Lyocell—One Fiber, Many Faces,” http://ohioline.osu.edu/hyg-fact/5000/5572.html, 5 pages, date printed Sep. 18, 2006; and “Lyocell,” http://en.wikipedia.org/wiki/Lyocell, 2 pages, date printed Sep. 18, 2006.

The nonwoven substrate can contain a sufficient amount of the regenerated cellulose fiber so that the wipe exhibits desirable cloth and hand feel characteristics. The natural fiber can provide a nonwoven substrate for use as a wipe that is relatively inexpensive, but has a tendency to provide the wipe with stiffness. Regenerated cellulose fiber can be included in the nonwoven substrate in an amount sufficient to improve the cloth and hand feel characteristics of the nonwoven substrate.

The nonwoven substrate can be prepared from fibers containing natural fiber, regenerated cellulose fiber, or a mixture of natural fiber and regenerated cellulose fiber. The nonwoven substrate can contain 0 wt. % to 100 wt. % natural fiber and can contain 0 wt. % to 100 wt. % regenerated cellulose fiber, based on the weight of the fiber of the nonwoven substrate. In order to provide the nonwoven substrate with desired cloth and hand feel properties or to provide the nonwoven substrate with desired air permeability, the nonwoven substrate can be prepared from a mixture of natural fiber and regenerated cellulose fiber. The nonwoven substrate can be prepared from a mixture containing about 10 wt. % to about 95 wt. % natural fiber, about 20 wt. % to about 92 wt. % natural fiber, about 40 wt. % to about 90 wt. % natural fiber, or about 50 wt. % to about 85 wt. % natural fiber. The nonwoven substrate can be prepared from a mixture containing about 0.5 wt. % to about 75 wt. % regenerated cellulose fiber, about 2 wt. % to about 60 wt. % regenerated cellulose fiber, about 10 wt. % to about 55 wt. % regenerated cellulose fiber, or about 20 wt. % to about 50 wt. % regenerated cellulose fiber. The weight percent of fiber is based upon the fiber content of the nonwoven substrate.

It can be desirable to provide the regenerated cellulose fiber having a length that is as long as possible to form a nonwoven substrate on a paper making machine in order to obtain the maximum benefit of the presence of the regenerated cellulose fiber. In general, it is expected that by using a longer regenerated cellulose fiber, it may be possible to use less of the regenerated cellulose fiber prepared with a nonwoven substrate that uses shorter fiber. In general, an exemplary regenerated cellulose fiber length that can be used on a paper making machine is about 3 mm to about 6 mm (about ⅛ inch to about ¼ inch). It may be desirable to provide the regenerated cellulose fiber having a length of up to about 2 inches.

The regenerated cellulose fiber can have a denier selected to provide desired cloth or hand feel characteristics. In general, a small denier can be used to enhance the cloth or hand feel characteristics. Fibers having a larger denier tend to be more coarse. Accordingly, the regenerated cellulose fiber can have a denier of about 0.5 to about 20, a denier of about 0.5 to about 10, a denier of about 0.5 to about 5, or a denier of about 1.0 to about 2.

The nonwoven substrate can be provided having a basis weight that provides a wipe having sufficient feel, absorbency, and durability for wiping a surface. When used to wipe a hard surface, for example, the nonwoven substrate can have a basis weight so that it does not feel flimsy. In addition, the nonwoven substrate should not have a basis weight that is so high so that it feels too stiff. For example, the nonwoven substrate can have a basis weight of about 10 lb/3,000 ft² to about 50 lb/3,000 ft², about 20 lb/3,000 ft² to about 40 lb/3,000 ft², or about 25 lb/3,000 ft² to about 35 lb/3,000 ft².

The nonwoven substrate can be formed by a wet laid process. Exemplary wet laid processes that can be used include those wet laid processes that are generally considered paper making processes and wet laid processes that are often used to make nonwovens other than paper or in addition to paper. Exemplary paper making wet laid processes include these processes carried out on a paper making machine such as a Fourdrinier machine. Additional paper making processes include processes carried out on a twin wire machine or on a cylinder machine. An additional wet laid process that can be used for making nonwovens can be carried out on as an inclined wire machine. An exemplary inclined wire machine is a Hydroformer machine.

The fibers for use in forming the nonwoven substrate can be fibers that are convenient for use on a paper making machine. During a paper making process, a wet mass of fibers is typically applied to a wire or screen to form a substrate, and the substrate is subsequently dried by running the substrate over heated cans.

When processing natural fibers such as wood pulp to form the nonwoven substrate, it can be desirable to process the fiber in a wet laid process such as on a paper making machine. However, when the natural fiber is not wood pulp or when the fiber is entirely or almost entirely regenerated cellulose fiber, it may be desirable to use another nonwoven substrate forming technique such as air laid, spun bond, melt blown, to form the nonwoven substrate.

The nonwoven substrate can include additives such as a wet strength additive to help hold the fiber together. Exemplary wet strength additives that can be used to hold the fiber together and maintain strength when wet include urea formaldehyde resin (e.g., Amres PR-247HV from Georgia Pacific Resins), melamine formaldehyde resin (e.g., Parez 607 from Cytec Industries, Inc.), polyamides, polyacrylamides, polyimines, polyethyleneimines (PEI), wet end latexes, size press latexes (e.g., polyacrylates, styrene, butadiene, copolymers, styrene acrylic copolymers, ethylene, vinyl acetate copolymers, nitrile rubbers, polyvinyl chloride, polyvinyl acetate, ethylene acrylate copolymers, vinyl acetate acrylate copolymers, or mixtures thereof). An exemplary polyamide is polyamide epichlorohydrin resin (PAE) (Kymene 970 resin available from Hercules, Inc.). If the nonwoven substrate includes a wet strength additive, the nonwoven substrate can contain about 0.1 wt. % to about 8 wt. % of the wet strength additive, or about 1 wt. % to about 4 wt. % of the wet strength additive.

The nonwoven substrate can include a binder to help hold the fiber together. Exemplary binders that can be used include latexes. The addition of a binder such as a latex can be referred to as a form of chemical bonding. The latexes can be provided as polyacrylates, styrene, butadiene, copolymers, styrene acrylic copolymers, ethylene, vinyl acetate copolymers, nitrile rubbers, polyvinyl chloride, polyvinyl acetate, ethylene acrylate copolymers, vinyl acetate acrylate copolymers, or mixtures thereof. When the nonwoven substrate includes a binder, the nonwoven substrate can include the binder in an amount of about 0.5 wt. % to about 25 wt. %, and can include the binder in an amount of about 2 wt. % to about 15 wt. %.

The nonwoven substrate can be provided without a binder. It should be understood that the term “binder” refers to a chemical binding agent. Other forms of binding can occur in the nonwoven substrate. For example, there can be mechanical binding. An example of mechanical binding includes entanglement. The fibers of the nonwoven substrate can be hydroentangled, if desired. In addition, binding can occur as a result of melting or softening of fibers and the fibers thereby sticking together. Polylactide, for example, can melt or soften to provide by bonding. Various techniques for providing binding include thermal bonding (e.g., using fusible fibers, bicomponent fibers, calender bonding or ultrasonics), hydrogen bonding (e.g., of the cellulosic fibers), or mechanical bonding (hydroentanglement, needlepunch, or stitchbonding).

### Creping

The nonwoven substrate can be creped. In general, creping a substrate can be desirable to modify properties of the substrate. For example, creping can be used to enhance loft or hand feel properties, increase flexibility, increase stretch, and/or increase openness of the substrate relative to the flat sheet. The flat sheet refers to the nonwoven substrate prior to creping. Once the nonwoven substrate has been creped, it can be referred to as a creped substrate. It can be fairly convenient to crepe the nonwoven substrate after it has been prepared as a result of a wet laid process. Once the nonwoven substrate has been formed as a result of the wet laid process, a creping step can be conveniently added to the process to provide a desired level of creping. Techniques for creping a nonwoven substrate are disclosed in U.S. application Ser. No. 11/080,346 that was filed with the United States Patent and Trademark Office on Mar. 15, 2005. The entire disclosure of U.S. application Ser. No. 11/080,346 is incorporated herein by reference.

One of skill in the art will appreciate that many different methods may be used to crepe paper. An exemplary creping press can include a first crepe press roll made of a soft material and a second crepe press roll made of a more rigid material such as steel. The substrate can travel between the rolls and adhere to and follow the second crepe press roll. The substrate can be creped off the second crepe press roll using a doctor blade (or creping blade) to produce a rough creped paper substrate.

The substrate that is creped can be characterized as wet or dry. Creping a wet substrate can be referred to as wet creping, and creping a dry substrate can be referred to as dry creping. In the case of wet creping, it can be desirable for the substrate to have a water content of about 20 wt. % to about 65 wt. %. In addition, the substrate can have a moisture content of about 35 wt. % to about 60 wt. %. Dry creping is generally characterized as creping a substrate having a moisture content of less than about 20 wt. %.

Creping can impart a degree of stretchability or elongation to a substrate. Elongation properties may be measured according to TAPPI test T494. The substrate can be creped to provide a creped paper product having an elongation of at least about 1% in the machine direction (MD) according to TAPPI test T494. In addition, the substrate can be creped to provide an elongation of at least about 2% in the machine direction, and can be creped to provide an elongation of at least 3% in the machine direction, according to TAPPI test T494. Although the substrate can be creped to provide a crepe paper product having the desired elongation, it is generally expected that the elongation will be less than about 30% in the machine direction (MD) according to TAPPI test T494. The creped paper product can be provided having an elongation of about 3% to about 15% in the machine direction (MD) according to TAPPI test T494, and can be provided having an elongation of about 4% to about 10% in the machine direction according to TAPPI test T494.

The creping process results in the formation of creping lines on the rough creped paper substrate. In general, creped paper having a relatively low number of lines per lineal inch can be associated with heavy papers that are generally more abrasive and rougher compared with creped paper having more crepe lines per lineal inch to produce lighter papers that are finer and smoother. It should be understood that this is just a general characterization and heavy papers can include a higher number of crepe lines per lineal inch than lighter papers. When providing more abrasive and rougher creped paper, the creping process can provide about 5 to about 15 crepe lines per lineal inch. For finer and smoother creped paper products, it may be desirable to provide at least about 15 crepe lines per lineal inch. It is expected that the number of crepe lines can be as large as desired for a particular application. For example, it may be desirable to provide creped paper having in excess of 100 crepe lines per lineal inch. For example, it may be desirable to provide creped paper having up to about 200 crepe lines per lineal inch. The creped paper product can include crepe lines of about 15 to about 100 per lineal inch, about 17 to about 50 per lineal inch, and about 20 to about 30 per lineal inch.

### Active Agent Containing Composition

The wipe can contain an active agent containing composition that contains an active agent to assist with the use of the wipe. The active agent containing composition can be included with the nonwoven substrate to provide cleaning properties, disinfectant properties, deodorizing properties, moisturizing properties fragrance properties, etc. An active agent containing composition that provides cleaning properties can be referred to as a cleaning composition. An active agent containing composition that provides disinfectant properties can be referred to as a disinfectant composition. Additional compositions containing the various active agents can be referred to as, for example, moisturizing compositions, abrasive compositions, deodorizing compositions, etc. The active agent can be a surfactant, organic solvent, disinfectant, antibacterial agent, bacteriostat, pH adjuster, abrasive, colorant, viscosity bodying agent, moisturizer, perfume, deodorizer, or mixture thereof. It should be understood that the weight percentages of the components identified in the active agent containing composition are based upon the weight of the active agent containing composition.

### Surfactant

The active agent containing composition can be provided as a cleaning composition containing at least one surfactant. Exemplary surfactants include anionic, nonionic, cationic, ampholytic, amphoteric, zwitterionic surfactants, and mixtures thereof. A typical listing of anionic, nonionic, ampholytic, and zwitterionic classes, and species of these surfactants, is given in U.S. Pat. No. 3,929,678 to Laughlin et al. A list of suitable cationic surfactants is given in U.S. Pat. No. 4,259,217 to Murphy. Where present, ampholytic, amphoteric and zwitterionic surfactants are generally used in combination with one or more anionic and/or nonionic surfactants. The surfactants may be present at a level of from 0 wt. % to 5 wt. %, or from 0.001 wt. % to 2 wt. %, or from 0.01 wt. % to 0.5 wt. %. Where concentrated cleaning solutions are required, the surfactants may be present at a level of from 5 wt. % to 50 wt. %, or from 5 wt. % to 20 wt. %, or from 5 wt. % to 10 wt. %. Where dry-to-the-touch cleaning solutions are required, the surfactants may be present at a level of from 5 wt. % to 100 wt. %, or from 10 wt. % to 90 wt. %, or from 50 wt. % to 70 wt. %.

The cleaning composition may comprise an anionic surfactant. Essentially any anionic surfactants useful for detersive purposes can be comprises in the cleaning composition. These can include salts (including, for example, sodium, potassium, ammonium, and substituted ammonium salts such as mono-, di- and tri-ethanolamine salts) of the anionic sulfate, sulfonate, carboxylate and sarcosinate surfactants. Anionic surfactants may comprise a sulfonate or a sulfate surfactant. Anionic surfactants may comprise an alkyl sulfate, a linear or branched alkyl benzene sulfonate, or an alkyldiphenyloxide disulfonate, as described herein.

Other anionic surfactants include the isethionates such as the acyl isethionates, N-acyl taurates, fatty acid amides of methyl tauride, alkyl succinates and sulfosuccinates, monoesters of sulfosuccinate (for instance, saturated and unsaturated C12-C18 monoesters) diesters of sulfosuccinate (for instance saturated and unsaturated C6-C14 diesters), N-acyl sarcosinates. Resin acids and hydrogenated resin acids are also suitable, such as rosin, hydrogenated rosin, and resin acids and hydrogenated resin acids present in or derived from tallow oil. Anionic sulfate surfactants suitable for use herein include the linear and branched primary and secondary alkyl sulfates, alkyl ethoxysulfates, fatty oleoyl glycerol sulfates, alkyl phenol ethylene oxide ether sulfates, the C5-C17acyl-N—(C1-C4 alkyl) and —N—(C1-C2 hydroxyalkyl) glucamine sulfates, and sulfates of alkylpolysaccharides such as the sulfates of alkylpolyglucoside (the nonionic nonsulfated compounds being described herein). Alkyl sulfate surfactants may be selected from the linear and branched primary C10-C18 alkyl sulfates, the C11-C15 branched chain alkyl sulfates, or the C12-C14 linear chain alkyl sulfates.

Alkyl ethoxysulfate surfactants can be selected from the group consisting of the C10-C18 alkyl sulfates which have been ethoxylated with from 0.5 to 20 moles of ethylene oxide per molecule. The alkyl ethoxysulfate surfactant can be a C1′-C18, or a C1′-C15 alkyl sulfate which has been ethoxylated with from 0.5 to 7, or from 1 to 5, moles of ethylene oxide per molecule. One aspect of the invention employs mixtures of alkyl sulfate and/or sulfonate and alkyl ethoxysulfate surfactants. Such mixtures have been disclosed in PCT Patent Application No. WO 93/18124.

Anionic sulfonate surfactants suitable for use herein include the salts of C5-C20 linear alkylbenzene sulfonates, alkyl ester sulfonates, C6-C22 primary or secondary alkane sulfonates, C6-C24 olefin sulfonates, sulfonated polycarboxylic acids, alkyl glycerol sulfonates, fatty acyl glycerol sulfonates, fatty oleyl glycerol sulfonates, and any mixtures thereof. Suitable anionic carboxylate surfactants include the alkyl ethoxy carboxylates, the alkyl polyethoxy polycarboxylate surfactants and the soaps (‘alkyl carboxyls’), especially certain secondary soaps as described herein. Suitable alkyl ethoxy carboxylates include those with the formula RO(CH₂CH₂O)ₙCH₂COO⁻M⁺ wherein R is a C6 to C18 alkyl group, x ranges from 0 to 10, and the ethoxylate distribution is such that, on a weight basis, the amount of material where x is 0 is less than 20% and M is a cation. Suitable alkyl polyethoxypolycarboxylate surfactants include those having the formula RO—(CHR¹—CHR²—O)—R³ wherein R is a C6 to C18 alkyl group, x is from 1 to 25, R¹ and R² are selected from the group consisting of hydrogen, methyl acid radical, succinic acid radical, hydroxysuccinic acid radical, and mixtures thereof, and R³ is selected from the group consisting of hydrogen, substituted or unsubstituted hydrocarbon having between 1 and 8 carbon atoms, and mixtures thereof.

Exemplary soap surfactants include the secondary soap surfactants, which contain a carboxyl unit connected to a secondary carbon. Secondary soap surfactants for use herein include water-soluble members selected from the group consisting of the water-soluble salts of 2-methyl-1-undecanoic acid, 2-ethyl-1-decanoic acid, 2-propyl-1-nonanoic acid, 2-butyl-1-octanoic acid and 2-pentyl-1-heptanoic acid. Certain soaps may also be included as suds suppressors.

Other exemplary anionic surfactants are the alkali metal sarcosinates of formula R—CON(R¹) CH—)COOM, wherein R is a C5-C17 linear or branched alkyl or alkenyl group, R¹ is a C1-C4 alkyl group and M is an alkali metal ion. Examples are the myristyl and oleoyl methyl sarcosinates in the form of their sodium salts.

Essentially any alkoxylated nonionic surfactants are suitable herein. The ethoxylated and propoxylated nonionic surfactants are suitable. Alkoxylated surfactants can be selected from the classes of the nonionic condensates of alkyl phenols, nonionic ethoxylated alcohols, nonionic ethoxylated/propoxylated fatty alcohols, nonionic ethoxylate/propoxylate condensates with propylene glycol, and the nonionic ethoxylate condensation products with propylene oxide/ethylene diamine adducts.

The condensation products of aliphatic alcohols with from 1 to 25 moles of alkylene oxide, particularly ethylene oxide and/or propylene oxide, are suitable for use herein. The alkyl chain of the aliphatic alcohol can either be straight or branched, primary or secondary, and generally contains from 6 to 22 carbon atoms. Also suitable are the condensation products of alcohols having an alkyl group containing from 8 to 20 carbon atoms with from 2 to 10 moles of ethylene oxide per mole of alcohol.

Polyhydroxy fatty acid amides suitable for use herein are those having the structural formula R²CONR¹Z wherein: R¹ is H, C1-C4 hydrocarbyl, 2-hydroxyethyl, 2-hydroxypropyl, ethoxy, propoxy, or a mixture thereof, or C1-C4 alkyl, or C1 or C2 alkyl, or C1 alkyl (i.e., methyl); and R² is a C5-C31 hydrocarbyl, or straight-chain C5-C19 alkyl or alkenyl, or straight-chain C9-C17 alkyl or alkenyl, or straight-chain C11-C17 alkyl or alkenyl, or mixture thereof-, and Z is a polyhydroxyhydrocarbyl having a linear hydrocarbyl chain with at least 3 hydroxyls directly connected to the chain, or an alkoxylated derivative (for example, ethoxylated or propoxylated) thereof. Z can be derived from a reducing sugar in a reductive amination reaction; for example, Z is a glycityl.

Exemplary fatty acid amide surfactants include those having the formula: R¹CON(R²)₂ wherein R¹ is an alkyl group containing from 7 to 21, or from 9 to 17 carbon atoms and each R² is selected from the group consisting of hydrogen, C1-C4 alkyl, C1-C4 hydroxyalkyl, and —(C2H₄₀)ₓH, where x is in the range of from 1 to 3.

Exemplary alkylpolysaccharides for use herein are disclosed in U.S. Pat. No. 4,565,647 to Llenado, having a hydrophobic group containing from 6 to 30 carbon atoms and a polysaccharide, e.g., a polyglycoside, hydrophilic group containing from 1.3 to 10 saccharide units. Alkylpolyglycosides may have the formula: R²O(CₙH₂ₙO)ₜ(glycosyl)ₓ wherein R² is selected from the group consisting of alkyl, alkylphenyl, hydroxyalkyl, hydroxyalkylphenyl, and mixtures thereof in which the alkyl groups contain from 10 to 18 carbon atoms; n is 2 or 3; t is from 0 to 10, and x is from 1.3 to 8. The glycosyl may be derived from glucose.

Exemplary amphoteric surfactants for use herein include the amine oxide surfactants and the alkyl amphocarboxylic acids. Suitable amine oxides include those compounds having the formula R³(OR⁴)ₓNO(R⁵)₂ wherein R³ is selected from an alkyl, hydroxyalkyl, acylamidopropyl and alkylphenyl group, or mixtures thereof, containing from 8 to 26 carbon atoms; R⁴ is an alkylene or hydroxyalkylene group containing from 2 to 3 carbon atoms, or mixtures thereof-, x is from 0 to 5, preferably from 0 to 3; and each R⁵ is an alkyl or hydroxyalkyl group containing from 1 to 3, or a polyethylene oxide group containing from 1 to 3 ethylene oxide groups. Examples are C10-C18 alkyl dimethylamine oxide, and C10-18 acylamido alkyl dimethylamine oxide. A suitable example of an alkyl amphodicarboxylic acid is Miranol™ C2M Conc. manufactured by Miranol, Inc., Dayton, N.J.

Zwitterionic surfactants can also be used. These surfactants can be broadly described as derivatives of secondary and tertiary amines, derivatives of heterocyclic secondary and tertiary amines, or derivatives of quaternary ammonium, quaternary phosphonium or tertiary sulfonium compounds. Betaine and sultaine surfactants are exemplary zwittenionic surfactants for use herein.

Exemplary betaines are those compounds having the formula R(R¹)₂N⁺R²COO⁻ wherein R is a C6-C18 hydrocarbyl group, each R¹ is typically C1-C3 alkyl, and R² is a C1-C5 hydrocarbyl group. Examples are C12-18 dimethyl-ammonio hexanoate and the C10-18 acylamidopropane (or ethane) dimethyl (or diethyl) betaines. Complex betaine surfactants are also suitable for use herein.

Exemplary cationic surfactants to be used herein include the quaternary ammonium surfactants. The quaternary ammonium surfactant can be a mono C6-C16, or C6-C10 N-alkyl or alkenyl ammonium surfactants wherein the remaining N positions are substituted by methyl, hydroxyethyl or hydroxypropyl groups. Examples are also the mono-alkoxylated and bis-alkoxylated amine surfactants.

Another suitable group of cationic surfactants, which can be used in the detergent compositions or components thereof herein, are cationic ester surfactants. The cationic ester surfactant is a, often water dispersible, compound having surfactant properties comprising at least one ester (i.e. —COO—) linkage and at least one cationically charged group. Suitable cationic ester surfactants, including choline ester surfactants, have for example been disclosed in U.S. Pat. Nos. 4,228,042, 4,239,660 and 4,260,529. The ester linkage and cationically charged group may be separated from each other in the surfactant molecule by a spacer group consisting of a chain comprising at least three atoms (i.e. of three atoms chain length), or from three to eight atoms, or from three to five atoms, or three atoms. The atoms forming the spacer group chain are selected from the group consisting, of carbon, nitrogen and oxygen atoms and any mixtures thereof, with the proviso that any nitrogen or oxygen atom in said chain connects only with carbon atoms in the chain. Thus spacer groups having, for example, —O—O— (i.e. peroxide), —N—N—, and —N—O— linkages are excluded, whilst spacer groups having, for example —CH₂—O—, CH₂— and —CH₂—NH—CH₂— linkages are included. The spacer group chain may comprise only carbon atoms, or the chain is a hydrocarbyl chain.

The cleaning composition may comprise cationic mono-alkoxylated amine surfactants, for instance, of the general formula: R¹R²R³N⁺ApR⁴ X⁻ wherein R¹ is an alkyl or alkenyl moiety containing from about 6 to about 18 carbon atoms, or from 6 to about 16 carbon atoms, or from about 6 to about 14 carbon atoms; R² and R³ are each independently alkyl groups containing from one to about three carbon atoms, for instance, methyl, for instance, both R² and R³ are methyl groups; R⁴ is selected from hydrogen, methyl and ethyl; X⁻ is an anion such as chloride, bromide, methylsulfate, sulfate, or the like, to provide electrical neutrality; A is a alkoxy group, especially a ethoxy, propoxy or butoxy group; and p is from 0 to about 30, or from 2 to about 15, or from 2 to about 8. The ApR⁴ group in the formula may have p=1 and is a hydroxyalkyl group, having no greater than 6 carbon atoms whereby the —OH group is separated from the quaternary ammonium nitrogen atom by no more than 3 carbon atoms. Suitable ApR⁴ groups are —CH₂CH₂—OH, —CH₂CH₂CH₂—OH, —CH₂CH(CH₃)—OH and —CH(CH₃)CH₂—OH. Suitable R¹ groups are linear alkyl groups, for instance, linear R¹ groups having from 8 to 14 carbon atoms.

Exemplary cationic mono-alkoxylated amine surfactants for use herein are of the formula R¹(CH₃)(CH₃)N⁺(CH₂CH₂O)₂₋₅HX⁻ wherein R¹ is C10-C18 hydrocarbyl and mixtures thereof, especially C10-C14 alkyl, or C10 and C12 alkyl, and X is any convenient anion to provide charge balance, for instance, chloride or bromide.

As noted, compounds of the foregoing type include those wherein the ethoxy (CH₂CH₂O) units (EO) are replaced by butoxy, isopropoxy [CH(CH₃)CH₂O] and [CH₂CH(CH₃)O] units (i-Pr) or n-propoxy units (Pr), or mixtures of EO and/or Pr and/or i-Pr units.

The cationic bis-alkoxylated amine surfactant may have the general formula: R¹R²N⁺ApR³A′qR⁴X⁻ wherein R¹ is an alkyl or alkenyl moiety containing from about 8 to about 18 carbon atoms, or from 10 to about 16 carbon atoms, or from about 10 to about 14 carbon atoms; R² is an alkyl group containing from one to three carbon atoms, for instance, methyl; R³ and R⁴ can vary independently and are selected from hydrogen, methyl and ethyl, X⁻ is an anion such as chloride, bromide, methylsulfate, sulfate, or the like, sufficient to provide electrical neutrality. A and A′ can vary independently and are each selected from C1-C4 alkoxy, for instance, ethoxy, (i.e., —CH₂CH₂O—), propoxy, butoxy and mixtures thereof, p is from 1 to about 30, or from 1 to about 4 and q is from 1 to about 30, or from 1 to about 4, or both p and q are 1.

Suitable cationic bis-alkoxylated amine surfactants for use herein are of the formula R¹CH₃N⁺(CH₂CH₂OH)(CH₂CH₂OH)X⁻ wherein R¹ is C10-C18 hydrocarbyl and mixtures thereof, or C10, C12, C14 alkyl and mixtures thereof, X⁻ is any convenient anion to provide charge balance, for example, chloride. With reference to the general cationic bis-alkoxylated amine structure noted above, since in one example compound R¹ is derived from (coconut) C12-C14 alkyl fraction fatty acids, R² is methyl and ApR³ and A′qR⁴ are each monoethoxy.

Other cationic bis-alkoxylated amine surfactants useful herein include compounds of the formula: R¹R²N⁺—(CH₂CH₂O)ₚH—(CH₂CH₂O)_{q}HX⁻. wherein R¹ is C10-C18 hydrocarbyl, or C10-C14 alkyl, independently p is 1 to about 3 and q is 1 to about 3, R² is C1-C3 alkyl, for example, methyl, and X⁻ is an anion, for example, chloride or bromide.

Other compounds of the foregoing type include those wherein the ethoxy (CH₂CH₂O) units (EO) are replaced by butoxy (Bu) isopropoxy [CH(CH₃)CH₂O] and [CH₂CH(CH₃)O] units (i-Pr) or n-propoxy units (Pr), or mixtures of EO and/or Pr and/or i-Pr units.

The inventive compositions may include at least one fluorosurfactant selected from nonionic fluorosurfactants, cationic fluorosurfactants, and mixtures thereof which are soluble in the aqueous compositions being taught herein, particularly compositions which do not include further detersive surfactants, or further organic solvents, or both. Useful nonionic fluorosurfactant compounds are found among the materials presently commercially marketed under the tradename Fluorad® (ex. 3M Corp.) Exemplary useful fluorosurfactants include those sold as Fluorad® FC-740, generally described to be fluorinated alkyl esters; Fluorad® FC-430, generally described to be fluorinated alkyl esters; Fluorad® FC-431, generally described to be fluorinated alkyl esters; and, Fluorad® FC-170-C, which is generally described as being fluorinated alkyl polyoxyethylene ethanols.

Suitable nonionic fluorosurfactant compounds include those which is believed to conform to the following formulation: CₙF₂ₙ₊₁SO₂N(C2H₅)(CH₂CH₂O)ₓCH₃ wherein: n has a value of from 1-12, or from 4-12, or 8; x has a value of from 4-18, or from 4-10, or 7; which is described to be a nonionic fluorinated alkyl alkoxylate and which is sold as Fluorad® FC-171 (3M Corp).

Additionally useful nonionic fluorosurfactant compounds are also found among the materials marketed under the tradename ZONYL® (DuPont Performance Chemicals). These include, for example, ZONYL® FSO and ZONYL® FSN. These compounds have the following formula: RfCH₂CH₂O(CH₂CH₂O)ₓH where Rf is F(CF₂CF₂)_{y}. For ZONYL® FSO, x is 0 to about 15 and y is 1 to about 7. For ZONYL® FSN, x is 0 to about 25 and y is 1 to about 9.

An example of a useful cationic fluorosurfactant compound has the following structure: CₙF₂ₙ₊₁SO₂NHC₃H₆N⁺(CH₃)₃F where n˜8. This cationic fluorosurfactant is available under the tradename Fluorad® FC-135 from 3M. Another example of a useful cationic fluorosurfactant is F₃—CF₂)ₙ— (CH₂)ₘSCH₂CHOH—CH₂—N⁺R₁R₂R₃ Cl⁻ wherein: n is 5-9 and m is 2, and R₁, R₂ and R₃ are —CH₃. This cationic fluorosurfactant is available under the tradename ZONYL® FSD (available from DuPont, described as 2-hydroxy-3-((gamma-omega-perfluoro-C₆₋₂₀-alkyl)thio)-N,N,N-trimethyl-1-propyl ammonium chloride). Other cationic fluorosurfactants suitable for use in the present invention are also described in EP 866,115 to Leach and Niwata.

The fluorosurfactant selected from the group of nonionic fluorosurfactant, cationic fluorosurfactant, and mixtures thereof may be present in amounts of from 0.001 wt. % to 5 wt. %, or from 0.01 wt. % to 1% wt. %, or from 0.01 wt. % to 0.5 wt. %.

### Water

The active agent containing composition can contain water, or can be free of water. When the active agent containing composition contains water, water can be provided in an amount of about 5 wt. % to about 90 wt. % based on the weight of the active agent containing composition. In addition, the active agent containing composition can contain about 15 wt. % to about 80 wt. % water, or about 20 wt. % to about 60 wt. % water. It should be understood that the reference to the amount of water or the amount of the active agent containing composition on the substrate refers to the amount provided on the substrate or provided in a packaging with the substrate. That is, the substrate can be packaged with the active agent containing composition so that, within the packaging, there is free active agent containing composition.

### Organic Solvent

Exemplary organic solvents that can be used include, but are not limited to, C₁₋₆ alkanols, C₁₋₆ diols, C₁₋₁₀ alkyl ethers of alkylene glycols, C₃₋₂₄ alkylene glycol ethers, polyalkylene glycols, short chain carboxylic acids, short chain esters, isoparafinic hydrocarbons, mineral spirits, alkylaromatics, terpenes, terpene derivatives, terpenoids, terpenoid derivatives, formaldehyde, and pyrrolidones. Alkanols include, but are not limited to, methanol, ethanol, n-propanol, isopropanol, butanol, pentanol, and hexanol, and isomers thereof. Diols include, but are not limited to, methylene, ethylene, propylene and butylene glycols. Alkylene glycol ethers include, but are not limited to, ethylene glycol monopropyl ether, ethylene glycol monobutyl ether, ethylene glycol monohexyl ether, diethylene glycol monopropyl ether, diethylene glycol monobutyl ether, diethylene glycol monohexyl ether, propylene glycol methyl ether, propylene glycol ethyl ether, propylene glycol n-propyl ether, propylene glycol monobutyl ether, propylene glycol t-butyl ether, di- or tri-polypropylene glycol methyl or ethyl or propyl or butyl ether, acetate and propionate esters of glycol ethers. Short chain carboxylic acids include, but are not limited to, acetic acid, glycolic acid, lactic acid and propionic acid. Short chain esters include, but are not limited to, glycol acetate, and cyclic or linear volatile methylsiloxanes. Water insoluble solvents such as isoparafinic hydrocarbons, mineral spirits, alkylaromatics, terpenoids, terpenoid derivatives, terpenes, and terpenes derivatives can be mixed with a water soluble solvent when employed.

Examples of organic solvent having a vapor pressure less than 0.1 mm Hg (20° C.) include, but are not limited to, dipropylene glycol n-propyl ether, dipropylene glycol t-butyl ether, dipropylene glycol n-butyl ether, tripropylene glycol methyl ether, tripropylene glycol n-butyl ether, diethylene glycol propyl ether, diethylene glycol butyl ether, dipropylene glycol methyl ether acetate, diethylene glycol ethyl ether acetate, and diethylene glycol butyl ether acetate (all available from ARCO Chemical Company).

The solvents can be present at a level of from 0.001 wt. % to 10 wt. %, or from 0.01 wt. % to 10 wt. %, or from 1 wt. % to 4 wt. % by weight.

### Additional Adjuncts

The cleaning compositions optionally contain one or more of the following adjuncts: stain and soil repellants, lubricants, odor control agents, perfumes, fragrances and fragrance release agents, and bleaching agents. Other adjuncts include, but are not limited to, acids, electrolytes, dyes and/or colorants, solubilizing materials, stabilizers, thickeners, defoamers, hydrotropes, cloud point modifiers, preservatives, and other polymers. The solubilizing materials, when used, include, but are not limited to, hydrotropes (e.g. water soluble salts of low molecular weight organic acids such as the sodium and/or potassium salts of toluene, cumene, and xylene sulfonic acid). The acids, when used, include, but are not limited to, organic hydroxy acids, citric acids, keto acid, and the like. Electrolytes, when used, include, calcium, sodium and potassium chloride. Thickeners, when used, include, but are not limited to, polyacrylic acid, xanthan gum, calcium carbonate, aluminum oxide, alginates, guar gum, methyl, ethyl, clays, and/or propyl hydroxycelluloses. Defoamers, when used, include, but are not limited to, silicones, aminosilicones, silicone blends, and/or silicone/hydrocarbon blends. Bleaching agents, when used, include, but are not limited to, peracids, hypohalite sources, hydrogen peroxide, and/or sources of hydrogen peroxide.

Preservatives, when used, include, but are not limited to, mildewstat or bacteriostat, methyl, ethyl and propyl parabens, short chain organic acids (e.g. acetic, lactic and/or glycolic acids), bisguanidine compounds (e.g. Dantagard and/or Glydant) and/or short chain alcohols (e.g. ethanol and/or IPA). The mildewstat or bacteriostat includes, but is not limited to, mildewstats (including non-isothiazolone compounds) include Kathon GC, a 5-chloro-2-methyl-4-isothiazolin-3-one, KATHON ICP, a 2-methyl-4-isothiazolin-3-one, and a blend thereof, and KATHON 886, a 5-chloro-2-methyl-4-isothiazolin-3-one, all available from Rohm and Haas Company; BRONOPOL, a 2-bromo-2-nitropropane 1, 3 diol, from Boots Company Ltd., PROXEL CRL, a propyl-p-hydroxybenzoate, from ICI PLC; NIPASOL M, an o-phenyl-phenol, Na.sup.+salt, from Nipa Laboratories Ltd., DOWICIDE A, a 1,2-Benzoisothiazolin-3-one, from Dow Chemical Co., and IRGASAN DP 200, a 2,4,4′-trichloro-2-hydroxydiphenylether, from Ciba-Geigy A.G.

### Antimicrobial Agent

Antimicrobial agents include quaternary ammonium compounds and phenolics. Non-limiting examples of these quaternary compounds include benzalkonium chlorides and/or substituted benzalkonium chlorides, di(C₆-C₁₄)alkyl di short chain (C₁₋₄ alkyl and/or hydroxyalkl) quaternaryammonium salts, N-(3-chloroallyl) hexaminium chlorides, benzethonium chloride, methylbenzethonium chloride, and cetylpyridinium chloride. Other quaternary compounds include the group consisting of dialkyldimethyl ammonium chlorides, alkyl dimethylbenzylammonium chlorides, dialkylmethylbenzylammonium chlorides, and mixtures thereof. Biguanide antimicrobial actives including, but not limited to polyhexamethylene biguanide hydrochloride, p-chlorophenyl biguanide; 4-chlorobenzhydryl biguanide, halogenated hexidine such as, but not limited to, chlorhexidine (1,1′-hexamethylene-bis-5-(4-chlorophen-yl biguanide) and its salts are also in this class.

### Builder/Buffer

The cleaning composition may include a builder or buffer, which increase the effectiveness of the surfactant. The builder or buffer can also function as a softener and/or a sequestering agent in the cleaning composition. A variety of builders or buffers can be used and they include, but are not limited to, phosphate-silicate compounds, zeolites, alkali metal, ammonium and substituted ammonium polyacetates, trialkali salts of nitrilotriacetic acid, carboxylates, polycarboxylates, carbonates, bicarbonates, polyphosphates, aminopolycarboxylates, polyhydroxysulfonates, and starch derivatives.

Builders or buffers can also include polyacetates and polycarboxylates. The polyacetate and polycarboxylate compounds include, but are not limited to, sodium, potassium, lithium, ammonium, and substituted ammonium salts of ethylenediamine tetraacetic acid, ethylenediamine triacetic acid, ethylenediamine tetrapropionic acid, diethylenetriamine pentaacetic acid, nitrilotriacetic acid, oxydisuccinic acid, iminodisuccinic acid, mellitic acid, polyacrylic acid or polymethacrylic acid and copolymers, benzene polycarboxylic acids, gluconic acid, sulfamic acid, oxalic acid, phosphoric acid, phosphonic acid, organic phosphonic acids, acetic acid, and citric acid. These builders or buffers can also exist either partially or totally in the hydrogen ion form.

The builder agent can include sodium and/or potassium salts of EDTA and substituted ammonium salts. The substituted ammonium salts include, but are not limited to, ammonium salts of methylamine, dimethylamine, butylamine, butylenediamine, propylamine, triethylamine, trimethylamine, monoethanolamine, diethanolamine, triethanolamine, isopropanolamine, ethylenediamine tetraacetic acid and propanolamine.

Buffering and pH adjusting agents, when used, include, but are not limited to, organic acids, mineral acids, alkali metal and alkaline earth salts of silicate, metasilicate, polysilicate, borate, hydroxide, carbonate, carbamate, phosphate, polyphosphate, pyrophosphates, triphosphates, tetraphosphates, ammonia, hydroxide, monoethanolamine, monopropanolamine, diethanolamine, dipropanolamine, triethanolamine, and 2-amino-2methylpropanol. Some examples are amino acids such as lysine or lower alcohol amines like mono-, di-, and tri-ethanolamine. Other nitrogen-containing buffering agents are tri(hydroxymethyl) amino methane (TRIS), 2-amino-2-ethyl-1,3-propanediol, 2-amino-2-methyl-propanol, 2-amino-2-methyl-1,3-propanol, disodium glutamate, N-methyl diethanolamide, 2-dimethylamino-2-methylpropanol (DMAMP), 1,3-bis(methylamine)-cyclohexane, 1,3-diamino-propanol N,N′-tetra-methyl-1,3-diamino-2-propanol, N,N-bis(2-hydroxyethyl)glycine (bicine) and N-tris(hydroxymethyl)methyl glycine (tricine). Other suitable buffers include ammonium carbamate, citric acid, acetic acid. Mixtures of any of the above are also acceptable. Useful inorganic buffers/alkalinity sources include ammonia, the alkali metal carbonates and alkali metal phosphates, e.g., sodium carbonate, sodium polyphosphate. For additional buffers see WO 95/07971, which is incorporated herein by reference. Other preferred pH adjusting agents include sodium or potassium hydroxide.

When employed, the builder, buffer, or pH adjusting agent comprises at least about 0.001% and typically about 0.01-5% of the cleaning composition. In one example, the builder or buffer content is about 0.01-2%.

### Pine Oil, Terpene Derivatives and Essential Oils

Compositions according to the invention may comprise pine oil, terpene derivatives and/or essential oils. Pine oil, terpene derivatives and essential oils are used primarily for cleaning efficacy. They may also provide some antimicrobial efficacy and deodorizing properties. They may also be advantageous when the wipe is intended to be used as a dust wipe for removing dust from a surface such as wood (e.g., furniture). Pine oil, terpene derivatives and essential oils may be present in the compositions in amounts of up to about 1 wt. %, or in amounts of 0.01 wt. % to 0.5 wt. %.

Pine oil is a complex blend of oils, alcohols, acids, esters, aldehydes and other organic compounds. These include terpenes which include a large number of related alcohols or ketones. Some important constituents include terpineol. One type of pine oil, synthetic pine oil, will generally contain a higher content of turpentine alcohols than the two other grades of pine oil, namely steam distilled and sulfate pine oils. Other important compounds include alpha- and beta-pinene (turpentine), abietic acid (rosin), and other isoprene derivatives. Particularly effective pine oils are commercially available from Mellennium Chemicals, under the Glidco tradename. These pine oils vary in the amount of terpene alcohols and alpha-terpineol.

Terpene derivatives appropriate for use in the inventive composition include terpene hydrocarbons having a functional group, such as terpene alcohols, terpene ethers, terpene esters, terpene aldehydes and terpene ketones. Examples of suitable terpene alcohols include verbenol, transpinocarveol, cis-2-pinanol, nopol, isoborneol, carbeol, piperitol, thymol, alpha-terpineol, terpinen-4-ol, menthol, 1,8-terpin, dihydro-terpineol, nerol, geraniol, linalool, citronellol, hydroxycitronellol, 3,7-dimethyl octanol, dihydro-myrcenol, tetrahydro-alloocimenol, perillalcohol, and falcarindiol. Examples of suitable terpene ether and terpene ester solvents include 1,8-cineole, 1,4-cineole, isobornyl methylether, rose pyran, menthofuran, trans-anethole, methyl chavicol, allocimene diepoxide, limonene mono-epoxide, isobornyl acetate, nonyl acetate, terpinyl acetate, linalyl acetate, geranyl acetate, citronellyl acetate, dihydro-terpinyl acetate and meryl acetate. Further, examples of suitable terpene aldehyde and terpene ketone solvents include myrtenal, campholenic aldehyde, perillaldehyde, citronellal, citral, hydroxy citronellal, camphor, verbenone, carvenone, dihydro-carvone, carvone, piperitone, menthone, geranyl acetone, pseudo-ionone, ionine, iso-pseudo-methyl ionone, n-pseudo-methyl ionone, iso-methyl ionone and n-methyl ionone.

Essential oils include, but are not limited to, those obtained from thyme, lemongrass, citrus, lemons, oranges, anise, clove, aniseed, pine, cinnamon, geranium, roses, mint, lavender, citronella, eucalyptus, peppermint, camphor, sandalwood, rosmarin, vervain, fleagrass, lemongrass, ratanhiae, cedar and mixtures thereof. Actives of essential oils to be used herein include, but are not limited to, thymol (present for example in thyme), eugenol (present for example in cinnamon and clove), menthol (present for example in mint), geraniol (present for example in geranium and rose), verbenone (present for example in vervain), eucalyptol and pinocarvone (present in eucalyptus), cedrol (present for example in cedar), anethol (present for example in anise), carvacrol, hinokitiol, berberine, ferulic acid, cinnamic acid, methyl salycilic acid, methyl salycilate, terpineol and mixtures thereof. Examples of actives of essential oils to be used herein are thymol, eugenol, verbenone, eucalyptol, terpineol, cinnamic acid, methyl salycilic acid, citric acid and/or geraniol.

Other essential oils include Anethole 20/21 natural, Aniseed oil china star, Aniseed oil globe brand, Balsam (Peru), Basil oil (India), Black pepper oil, Black pepper oleoresin 40/20, Bois de Rose (Brazil) FOB, Bomeol Flakes (China), Camphor oil, White, Camphor powder synthetic technical, Canaga oil (Java), Cardamom oil, Cassia oil (China), Cedarwood oil (China) BP, Cinnamon bark oil, Cinnamon leaf oil, Citronella oil, Clove bud oil, Clove leaf, Coriander (Russia), Coumarin 69.degree. (China), Cyclamen Aldehyde, Diphenyl oxide, Ethyl vanilin, Eucalyptol, Eucalyptus oil, Eucalyptus citriodora, Fennel oil, Geranium oil, Ginger oil, Ginger oleoresin (India), White grapefruit oil, Guaiacwood oil, Gurjun balsam, Heliotropin, Isobornyl acetate, Isolongifolene, Juniper berry oil, L-methhyl acetate, Lavender oil, Lemon oil, Lemongrass oil, Lime oil distilled, Litsea Cubeba oil, Longifolene, Menthol crystals, Methyl cedryl ketone, Methyl chavicol, Methyl salicylate, Musk ambrette, Musk ketone, Musk xylol, Nutmeg oil, Orange oil, Patchouli oil, Peppermint oil, Phenyl ethyl alcohol, Pimento berry oil, Pimento leaf oil, Rosalin, Sandalwood oil, Sandenol, Sage oil, Clary sage, Sassafras oil, Spearmint oil, Spike lavender, Tagetes, Tea tree oil, Vanilin, Vetyver oil (Java), Wintergreen. Each of these botanical oils is commercially available.

Oils include peppermint oil, lavender oil, bergamot oil (Italian), rosemary oil (Tunisian), and sweet orange oil. These may be commercially obtained from a variety of suppliers including: Givadan Roure Corp. (Clifton, N.J.); Berje Inc. (Bloomfield, N.J.); BBA Aroma Chemical Div. of Union Camp Corp. (Wayne, N.J.); Firmenich Inc. (Plainsboro N.J.); Quest International Fragrances Inc. (Mt. Olive Township, N.J.); Robertet Fragrances Inc. (Oakland, N.J.).

Particularly useful lemon oil and d-limonene compositions which are useful in the invention include mixtures of terpene hydrocarbons obtained from the essence of oranges, e.g., cold-pressed orange terpenes and orange terpene oil phase ex fruit juice, and the mixture of terpene hydrocarbons expressed from lemons and grapefruit.

The above specification, examples and data provide a complete description of the manufacture and use of the composition of the invention. Since many embodiments of the invention can be made without departing from the spirit and scope of the invention, the invention resides in the claims hereinafter appended.

We claim:

1. A wipe comprising:
(a) a nonwoven substrate comprising a mixture of natural fiber and regenerated cellulose fiber the mixture, comprising about 0.5 wt. % to about 75 wt. % of the regenerated cellulose fiber and about 10 wt. % to about 95 wt. % of the natural fiber, and having a basis weight of about 10 lb/3000 ft² to about 50 lb/3000 ft²; and
(b) an active agent containing composition in an amount of about 0.5 lb/3000 ft² to about 300 lb/3000 ft².

2. A wipe according to claim 1, wherein the natural fiber comprises wood fiber.

3. A wipe according to claim 2, wherein the wood fiber comprises a blend of hardwood fibers and soft wood fibers.

4. A wipe according to claim 1, wherein the natural fiber comprises non-wood fiber.

5. A wipe according to claim 4, wherein the non-wood fiber comprises at least one of vegetable fiber, cotton, straw, cane, grass, hemp, silk, corn stalk, abaca, or mixture thereof.

6. A wipe according to claim 1, wherein the mixture comprises about 10 wt. % to about 55 wt. % regenerated cellulose fiber and about 40 wt. % to about 90 wt. % natural fiber.

7. A wipe according to claim 1, wherein the active agent containing composition is loaded onto the nonwoven substrate in an amount of about 30 lb/3000 ft² to about 150 lb/3000 ft².

8. A wipe according to claim 1, wherein the nonwoven substrate has a basis weight of about 20 lb/3000 ft² to about 40 lb/3000 ft².

9. A wipe according to claim 1, wherein the nonwoven substrate contains about 0.1 wt. % to about 8 wt. % wet strength additive.

10. A wipe according to claim 9, wherein the wet strength additive comprises urea formaldehyde resin, melamine formaldehyde resin, polyamides, polyacrylamides, polyimines, polyethyleneimines, and latexes.

11. A wipe according to claim 1, wherein the nonwoven substrate comprises about 0.5 wt. % to about 25 wt. % binder.

12. A wipe according to claim 1, wherein the fibers are bound by entanglement, melting or softening of the regenerated cellulose fiber, or a combination thereof.

13. A wipe according to claim 1, wherein the active agent containing composition comprises about 0.001 wt. % to about 2 wt. % surfactant.

14. A wipe according to claim 1, wherein the active agent containing composition comprises about 0.001 wt. % to about 10 wt. % organic solvent.

15. A wipe according to claim 1, wherein the active agent containing composition comprises about 5 wt. % to about 90 wt. % water.

16. A wipe according to claim 1, wherein the active agent containing composition comprises about 0.1 wt. % to about 1 wt. % pine oil, terpene oil, or essential oil.

17. A wipe according to claim 1, wherein the wipe comprises a preservative, an antimicrobial agent, a builder, or a buffer.

18. A wipe according to claim 1, wherein the nonwoven substrate comprises a creped substrate.

19. A wipe according to claim 1, wherein the wipe is biodegradable according to ASTM D 6868-03.

20. A method for manufacturing a wipe comprising:
(a) forming a nonwoven substrate from a mixture of natural fiber and regenerated cellulose fiber by a wet laid process and having a basis weight of about 10 lb/3000 ft² to about 50 lb/3000 ft², wherein the mixture comprises about 0.5 wt. % to about 75 wt. % of the regenerated cellulose fiber and about 10 wt. % to about 95 wt. % of the natural fiber; and
(b) loading an active agent containing composition onto the nonwoven substrate in an amount of about 0.5 lb/3000 ft² to about 300 lb/3000 ft² to form the wipe.

21. A method according to claim 20, wherein the natural fiber comprises wood fiber.

22. A method according to claim 21, wherein the wood fiber comprises a blend of hardwood fibers and soft wood fibers.

23. A method according to claim 20, wherein the active agent is loaded onto the nonwoven substrate in an amount of about 30 lb/3000 ft² to about 150 lb/3000 ft².

24. A method according to claim 20, wherein the nonwoven substrate has a basis weight of about 20 lb/3000 ft² to about 40 lb/3000 ft².

25. A method according to claim 20, wherein the nonwoven substrate contains about 0.1 wt. % to about 8 wt. % wet strength additive.

26. A method according to claim 25, wherein the wet strength additive comprises urea formaldehyde resin, melamine formaldehyde resin, polyamides, polyacrylamides, polyimines, polyethyleneimines, and latexes.

27. A method according to claim 20, wherein the nonwoven substrate comprises about 0.5 wt. % to about 25 wt. % binder.

28. A method according to claim 20, wherein the fibers are bound by entanglement, melting or softening of the regenerated cellulose fiber, or a combination thereof.

29. A method according to claim 20, wherein the active agent containing composition comprises about 0.001 wt. % to about 2 wt. % surfactant.

30. A method according to claim 20, wherein the active agent containing composition comprises about 0.001 wt. % to about 10 wt. % organic solvent.

31. A method according to claim 20, wherein the active agent containing composition comprises about 5 wt. % to about 90 wt. % water.

32. A method according to claim 20, wherein the active agent containing composition comprises about 0.1 wt. % to about 1 wt. % pine oil, terpene oil, or essential oil.

33. A method according to claim 20, further comprising creping the nonwoven substrate.

34. A method according to claim 20, wherein the wipe is biodegradable according to ASTM D 6868-03.
